(19) United States
(12) Patent Application Publication
(10) Pub. No.: US 2024/0281886 A1
(43) Pub. Date: Aug. 22, 2024

(54) INFERRING AND/OR PREDICTING RELATIONSHIP RULES

(71) Applicant: Forensic Claims Solutions, LLC, Louisville, KY (US)

(72) Inventors: Michael McGauley, Louisville, KY (US); Steven Mills, Louisville, KY (US)

(21) Appl. No.: 18/169,946

(22) Filed: Feb. 16, 2023

(51) Int. Cl. G06Q 40/08

(52) U.S. Cl. CPC G06Q 40/08

(57) ABSTRACT

Techniques are described herein for inferring and/or detecting violation of relationship rules. In various implementations, an instance of digital claims data detailing a plurality of medical services for which a first entity compensated a second entity and one or more terms under which the medical services were compensated may be retrieved. Historical digital claims data of the first or second entity may be processed using multivariate analysis to infer one or more compensation relationship rules that govern compensation for medical services between the first and second entities. In response to a determination that one or more of the terms under which the medical services were compensated violate one or more of the rules that govern compensation between the first and second entities, a compensation reconciliation routine may be triggered on behalf of the second entity.

### BACKGROUND

In large industries like the health care industry, service providers such as hospitals, doctors offices, etc., provide myriad services to enormous numbers of patients. Compensation for these services is often provided by multiple different payors, such as the patients themselves and/or third parties such as insurance companies. Numerous standards and frameworks have been implemented to streamline the compensation process and gain various efficiencies. However, despite years of efforts to control compensation errors there are still significant problems plaguing the payment integrity industry. Currently 3-7% of all reimbursement errors involve overpayment, while underpayments comprise considerably less.

Identifying reimbursement errors can be challenging due to a variety of factors. Agreements between health care providers and payors are often difficult to access. These agreements may be kept confidential, or there may be technological reasons (e.g., system restrictions or deficiencies) that prevent sharing of these agreements. For example, different claims adjudication systems may have different technological capabilities, constraints, interfaces, etc. In some cases, claim compensation terms installed during adjudication conflict with paper counterparts. In many cases, agreements are not available in digital format, and paper agreements can be difficult to access and process, especially at scale. Medical privacy rules and regulations and the large amount of data may also make identifying reimbursement errors difficult.

### SUMMARY

Implementations are described herein for leveraging various techniques such as rules-based multivariate analysis and/or machine learning to infer and/or predict compensation relationship rules between entities, particularly medical providers and payors, as well as to identify potential violations of those compensation relationship rules. More particularly, but not exclusively, various types of multivariate analysis may be used to infer compensation relationship rule and/or violations thereof. Those violations may then be used to train machine learning model(s). As a consequence, the machine learning model(s) may be trained to approximate aspects (e.g., one or more functions) of the rules-based multivariate analysis and thereby usable to predict compensation relationship rules and/or violations thereof.

In some implementations, a method may be implemented by one or more processors and may include: retrieving an instance of digital claims data detailing a plurality of medical services for which a first entity compensated a second entity and one or more terms under which the medical services were compensated: processing historical digital claims data of the first or second entity using multivariate analysis to infer one or more compensation relationship rules that govern compensation for medical services between the first and second entities: in response to a determination that one or more of the terms under which the medical services were compensated violate one or more of the rules that govern compensation between the first and second entities, triggering a compensation reconciliation routine on behalf of the second entity; obtaining feedback based on the compensation reconciliation routine; and based on the feedback, training one or more machine learning models to generate, based on other instances of digital claims data detailing entities providing medical services to other entities, output indicative of other compensation relationship rules.

In various implementations, the processing may include processing both the historical digital claims data and the instance of digital claims data using multivariate analysis. In various implementations, the processing may include clustering the instance of digital claims data with additional instances of the historical claims data based on the plurality of medical services. In various implementations, the method may include: identifying a centroid of the cluster; and inferring one or more of the rules based on the centroid of the cluster. In various implementations, the method may include: determining a distance between an embedding representing the instance of digital claims data and the centroid; and determining that one or more of the terms violate one or more of the rules based on the distance.

In various implementations, the multivariate analysis may include a plurality of multivariate analysis techniques, and the method comprises determining that one or more of the terms under which the medical services were compensated violate one or more of the rules that govern compensation between the first and second entities based on outcomes of the plurality of multivariate analysis techniques. In various implementations, the plurality of multivariate analysis techniques include one or more of Z-scoring analysis, whisker and box quartile analysis, or banding.

In various implementations, the method may include processing the instance of digital claims data using one or more of the machine learning models to generate an embedding. In various implementations, the training may include training one or more of the machine learning models using a triplet loss function based on the embedding and two or more other embeddings generated from the historical digital claims data.

In various implementations, the method may include: processing the instance of digital claims data using one or more of the machine learning models to generate a prediction of whether one or more of the terms under which the medical services were compensated violate one or more of the rules that govern compensation between the first and second entities; comparing the prediction to the determination; and training one or more of the machine learning models based on the comparing.

In various implementations, the method may include: processing the instance of digital claims data using one or more of the machine learning models to predict one or more compensation rules under which the medical services were compensated: comparing the predicted one or more compensation rules to the inferred one or more compensation relationship rules; and training one or more of the machine learning models based on the comparing.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various embodiments.

FIG. 2 schematically depicts an example of how techniques described herein may be implemented, in accordance with various embodiments.

FIG. 3A and FIG. 3B schematically depict additional examples of how techniques described herein may be implemented, in accordance with various implementations.

FIG. 4A depicts an example graphical element that may be used to adjust various parameters used by various processes described herein, in accordance with various implementations.

FIG. 4B schematically demonstrates an example of risk tolerance levels that may be taken into account when adjusting parameters used by various processes described herein, in accordance with various implementations.

FIG. 5 depicts a flowchart illustrating an example method for practicing selected aspects of the present disclosure.

FIG. 6 illustrates an example architecture of a computing device.

### DETAILED DESCRIPTION

Implementations are described herein for leveraging various techniques such as rules-based multivariate analysis and/or machine learning to infer and/or predict compensation relationship rules between entities, particularly medical providers and payors, as well as to identify potential violations of those compensation relationship rules. More particularly, but not exclusively, various types of multivariate analysis may be used to infer compensation relationship rule and/or violations thereof. Those violations may then be used to train machine learning model(s). As a consequence, the machine learning model(s) may be trained to approximate aspects (e.g., one or more functions) of the rules-based multivariate analysis and thereby usable to predict compensation relationship rules and/or violations thereof.

As used herein, “rules-based” refers to logic/analysis that is based on defined rules and/or heuristics, e.g., a defined algorithm or mathematical function. Rules-based multivariate analysis may be implemented, for instance, via computer code that includes explicit instructions to perform specific operations on data to yield output(s) indicative of inferred compensation relationship rules and/or violations thereof. In contrast to rules-based logic, machine learning models are trained over time to “learn” mappings between inputs and outputs, and to approximate rules-based logic. As used herein, the terms “infer,” “inferring,” “inferred,” etc. will be used in the context of rules-based logic. The terms “predict,” “predicting.” “predicted,” etc. will be used in the context of applying data as input across one or more machine learning model(s) to generate predictions.

Compensation relationship rules that are inferred/predicted using techniques described herein may be compared to terms under which medical services are actually compensated. Violation of the compensation relationship rules by the term(s)—an overpayment, for instance—may trigger a compensation reconciliation routine in which various actions are performed automatically to reconcile individual compensations with the compensation relationship rules. For example, a report may be generated (e.g., for rendering on a display or printing) that conveys one or more instances of probable overpayment. As another example, if a measure of confidence that a relationship rule has been violated satisfies a threshold, in some implementations, a digital solicitation may be generated automatically and provided to an entity (pushed electronically or via an automatically printed paper mailing) whose term violated the relationship rule to solicit reconciliation from the entity. In some implementations, if yet another threshold is satisfied and the parties have agreed beforehand, the reconciliation routine could automatically debit funds from the payor and/or patient.

In some cases a proposed digital compensation may be analyzed similarly to a digital claim, proactively instead of reactively. Like with an already-paid digital claim, the proposed digital compensation may include one or more terms (e.g., reimbursement or payment amounts) to be satisfied in exchange for a plurality of services. Historical digital claims data may be processed to infer one or more compensation relationship rules between the medical provider and the payor. Then, the proposed terms of the proposed compensation may be compared to the compensation relationship rule(s). If one or more compensation relationship rules are not satisfied by the terms, appropriate personnel may be notified. Otherwise, if the compensation relationship rule(s) are satisfied by the terms of the proposed digital compensation, then the proposed digital compensation may be submitted and fulfilled automatically, without the need for human intervention. For example, funds may be withdrawn automatically from an account of the payor.

As noted previously, agreements between health care providers and payors are not made widely available. Consequently, they are not readily available to perform supervised training of machine learning models to generate output indicative of compensation relationship rules and/or violations. However, in various implementations, other rules-based techniques that do not use a trained machine learning model may be performed using historical claims data to identify claims that are outliers, e.g., because they likely violate compensation relationship rules. These rules-based techniques may in turn be used to perform initial training of one or more machine learning models (e.g., to transform randomly initiated weights to weights that at least partially fit the data).

For example, a given instance of digital claims data may identify a plurality of medical services for which a payor (e.g., an insurance company) compensated (e.g., reimbursed) a medical provider. This digital claims data may also indicate one or more terms under which the medical services were compensated. For example, the payor may have furnished reimbursement in specific amounts for particular medical services listed in the claim.

Historical digital claims data of the payor and/or medical provider may be processed using one or more multivariate analysis engines (which may be implemented using any combination of hardware and software) to determine whether the given instance of digital claims data evidences a violation of one or more compensation relationship rules. These multivariate analysis engines may implementation various types of rules-based multivariate analysis on the claims data to identify potential compensation relationship rules violations.

In some cases, a violation of a compensation relationship rule may be identified when two or more of these engines agree that a violation has occurred. Additionally or alternatively, a violation of a compensation relationship rule may be identified when one or more of the engines identifies the violation with a threshold confidence. In some implementations, the number of multivariate analysis engines that have to agree and/or the threshold confidence may be set by a user, e.g., using a graphical element provided as part of a graphical user interface (GUI). In some implementations, a single engine may be implemented, and compensation relationship rule violations may be identified based on one or more thresholds associated with the single engine.

In some implementations, rules-based multivariate analysis performed by one or more of the engines may include performing cluster and/or centroid analysis to determine how terms of the given instance of digital claims data measure up to the historical data. For example, clusters may be formed from historical claims involving the same or similar permutations of medical services. A data element (e.g., a vector or embedding) representing (e.g., encoding) the given instance of digital claims data may be examined against one or more of the clusters. If, for instance, a distance between the data element of the given instance of digital claims data and other data elements of a cluster (or the cluster's centroid) is too great, that may suggest the given instance of digital claims data violates one or more compensation relationship rules.

These engines and their rules-based multivariate analysis may be sufficient, without more, to identify compensation relationship rule violations. However, there may be a variety of technical advantages gained from leveraging rules-based multivariate analysis to train machine learning model(s). The rules-based multivariate analysis may include propriety techniques, whereas a machine learning model trained to act as a proxy for the multivariate analysis may not be readily interpretable by humans, and therefore can be more safely distributed. Additionally, once the machine learning model is trained, it may be used in parallel with the multivariate analysis, e.g., as an additional engine that can be used to corroborate or refute an identified compensation relationship rule violation.

Moreover, processing data using the machine learning model may conserve computing resources (e.g., memory, processor cycles, network bandwidth) compared to the multivariate analysis because the multivariate analysis may need to process large amounts of historical data each time a claim is examined. The machine learning model, by contrast, may not require input of historical data at each invocation: the weights of the model itself may be fitted to the historical data.

As another example, feedback received based on the outcome of multivariate analysis may not necessarily improve the multivariate analysis itself. Rather, a potential overpayment may simply be rejected, resulting in no compensation reconciliation. By contrast, if a machine learning model incorrectly classifies digital claims data as including an overpayment, negative feedback on that classification can be used as error to train the machine learning model, e.g., using techniques such as stochastic gradient descent and back propagation. Consequently, the machine learning model may be trained to approximate not only rules-based multivariate analysis, but human expertise as well. Contrastly, the quality of the rules-based multivariate analysis may be tied primarily to the quality of the historical data.

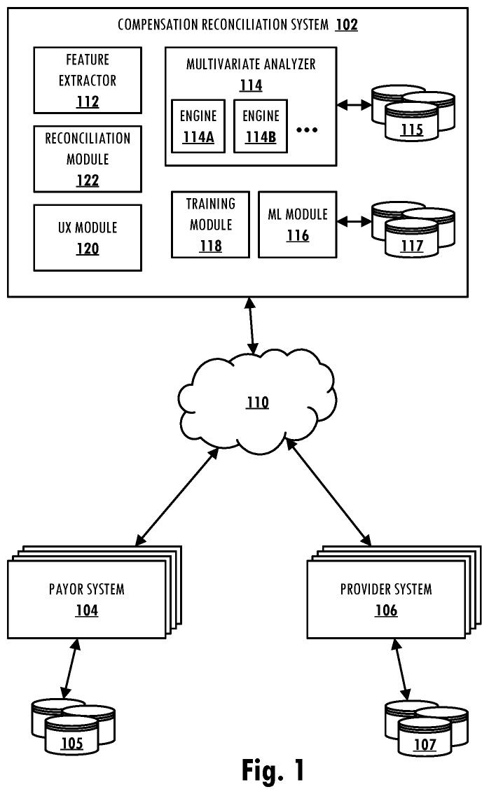

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”, tensor processing units or “TPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as a compensation reconciliation system 102, may be implemented using one or more server computing devices that form what is sometimes referred to as a “cloud infrastructure,” although this is not required.

Compensation reconciliation system 102 may be provided for helping various entities (including personnel employed by entities) infer and/or predict compensation relationship rules, and/or identify violations of the inferred and/or predicted compensation relationship rules. To this end, compensation reconciliation system 102 may be connected to one or more payer computer systems 104 and/or one or more provider computer systems 106 via one or more local area and/or wide area computer networks 110 (e.g., the Internet).

In some implementations, payor computer systems 104 may be operably coupled with one or more payer databases 105, which may store, for instance, historical digital claims data (all or part of which may be shared with a database 115), agreements that explicitly set forth compensation relationship rules between payors and providers, and so forth. Similarly, provider computer systems 106 may be operably coupled with one or more provider databases 107, which may store, for instance, historical digital claims data (all or part of which may be shared with database 115), agreements that explicitly set forth compensation relationship rules between payors and providers, and so forth. Notably, the agreements and/or contractual rules stored in databases 105, 107 may not be readily available to entities outside of payors or providers, for a variety of reasons such as privacy laws and regulations.

Compensation reconciliation system 102 may include various components that may be implemented using any combination of hardware and software, and which may be configured to carry out selected aspects of the present disclosure. In FIG. 1, for instance, compensation reconciliation system 102 includes a feature extractor 112, a multivariate analyzer 114, a machine learning (ML) module 116, a training module 118, a user interface (UX) module 120, and a reconciliation module 122. In other implementations, one or more of modules 112-122 may be combined, omitted, or implemented apart from compensation reconciliation system 102.

Feature extractor 112 may be configured to process one or more digital claims, such as a previously paid digital claim being reviewed after-the-fact or a digital claim for which payment term(s) are proposed, to extract various features. These features may include, for instance, line items contained in the digital claim, total prices of all items (e.g., where there is not a per-line-item cost, or where multiple services are bundled into a single line item), and so forth. Line items may identify medical goods or services provided (including Current Procedural Terminology (“CPT”) and/or Healthcare Common Procedure Coding System (“HCPCS”) codes), as well as terms under which the medical goods or services were compensated. For instance, a particular medical service such as an X-ray may be associated with a cost of $190. A surgery may be associated with a cost of $5,600, and a post-op procedure associated with the surgery may be associated with a cost of $530.

Feature extractor 112 may extract other types of features as well. For instance, a medical good or service may fall within one of multiple categories, such as inpatient, outpatient, skilled nursing, durable medical, home health, etc. Terms other than cost/price may also be inferred. For example, a type of payor or payment may include, for instance, different types of private insurance (e.g., provided by different entities, different types of plans), government issued insurance, etc. Claims may also include a single price for multiple goods/services, or individual prices for each line item.

Multivariate analyzer 114 may be configured to implement one or more engines 114A, 114B, . . . . Each engine 114 may be configured to perform a particular type of rules-based multivariate analysis based one or more of the features extracted by feature extractor 114, historical digital claims data 115 associated with payor(s) and/or health care provider(s), etc. This analysis may include, but is not limited to, cluster and/or centroid analysis. For example, a first engine 114A may be configured to perform Z-scoring analysis. A second engine 114B may be configured to perform whisker and box quartile analysis. Another engine (not depicted) may be configured to perform banding. And so on. Historical digital claims data 115 may include records of digital claims that have been compensated historically and may be obtained from sources such as databases 105 and/or 107. Historical digital claims data 115 may be used as reference data to infer and/or predict compensation relationship rules between various payors and providers, and/or to identify violations of these compensation relationship rules by individual terms of individual digital claims instances.

As one non-limiting example, in some implementations, an engine 114A of multivariate analyzer 114 may be configured to cluster an instance of digital claims data with additional instances of historical claims data based on a shared plurality of medical services. Engine 114A may then identify a centroid of the cluster and infer one or more compensation relationship rules based on the centroid of the cluster. For instance, engine 114A may determine a distance between an embedding representing the instance of digital claims data and the centroid, e.g., using techniques such as Euclidean distance, cosine similarity, dot product, etc. Based on that distance, and/or based on other data such as an average distance of all embeddings from the centroid, variances, standard deviations, etc., engine 114A may determine that one or more terms of the instance of digital claims data violate one or more of the compensation relationship rules. Intuitively, if all features other than prices are similar, it may be the prices that cause the embeddings to be distanced from each other and/or from the centroid of the cluster.

ML module 116 may be configured to process data indicative of digital claims, such as features extracted by feature extractor 112, using one or more machine learning models 117 to predict compensation relationship rules and/or violations thereof. Various types of regression and/or classification machine learning models 117 may be trained using techniques described herein to approximate various types of multivariate analysis, so that they can then be used to predict compensation relationship rules and/or potential compensation relationship rules violations. Neural networks of various forms may be employed, including but not limited to feed forward/multi-layer perception neural networks, convolutional neural networks (CNNs), various types of recurrent neural networks, various types of transformer networks (e.g., Bidirectional Encoder Representations from Transformers, General Purpose Transformer, etc.), and so forth. Other types of machine learning models may be trained as well, such as support vector machines (SVMs), decision trees, random forests, and so forth.

In some implementations, ML module 116 may apply one or more machine learning model(s) to semantically rich embeddings generated by feature extractor 112. To this end, feature extractor 112 may be configured to encode digital claims into embeddings using one or more machine learning model(s). For instance, a transformer machine learning model may be trained, e.g., by training module 118, using a corpus of historical digital claims data (e.g., 115), as well as annotations or classifications of those data (e.g., inferences generated by multivariate analyzer 114). Once trained, the transformer machine learning model may be used to transform instances of digital claims data into semantically rich embeddings that will be embedded near other semantically similar embeddings in embedding/latent space. ML module 116 may process these semantically rich embeddings using machine learning model(s) 117 to, for instance, classify underlying instances of digital claims data as including potential violations of compensation relationship rules.

Training module 118 may be configured to train machine learning model(s) 117 based on various signals and/or feedback. For example, the rules-based multivariate analysis performed by engines 114A, 114B, . . . may generate inferred compensation relationship rules and/or identified violations thereof. These inferred compensation relationship rules and/or identified violations thereof may be used by training module 118 as labels, along with corresponding instances of digital claims data that yielded those labels, to train machine learning model(s) 117, e.g., using techniques such as back propagation, gradient descent, Newton's method, conjugate gradient, the Levenberg-Marquardt algorithm, and so forth.

In some implementations, training module 118 may employ loss functions such as triplet loss to train one or more machine learning models 117 to embed digital claims data in proximity to semantically similar historical digital claims data in embedding/latent space. In some such implementations, this proximity may be calculated using techniques such as Euclidean distance, cosine similarity, dot product, etc. A subject digital claim under evaluation may be encoded/embedded in latent space to identify cluster(s) of historical embeddings (i.e., similar digital claims) to which the digital claim is similar. If, for instance, the subject digital claim's embedding is squarely in the middle of a cluster of similar digital claims, that may indicate a low probability that the subject digital claim violates any compensation relationship rule(s). However, if the subject digital claim's embedding is near, but distinctly outside of, one or more clusters, that may suggest that some feature(s) of the subject digital claim—compensation term(s), for instance, is an outlier of the same feature of the historical digital claims.

Once the machine learning model(s) 117 are sufficiently trained, they may be used, e.g., by ML module 116 (e.g., as an additional engine of multivariate analyzer 114), to process the same digital claims data that is processed by multivariate analyzer 114. In some cases, the relationship rules and/or violations predicted by ML module 116 may be generated in parallel with the inferences generated by other engines of multivariate analyzer 114, e.g., as additional conclusions that can be used to corroborate or refute other conclusions. Additionally or alternatively, the machine learning model(s) 117 may be used as a replacement of the other engines of multivariate analyzer 114, e.g., so that any proprietary techniques practiced by multivariate analyzer 114 can be kept private, if desired.

UX module 120 may be configured to provide an interface through which individuals (not depicted) can interact with compensation reconciliation system 102. In some implementations, UX module 120 may include a web server that generates and/or serves webpages composed in markup languages such as the hypertext markup language (HTML), the extensible markup language (XML), etc., that allow a user to review and/or evaluate inferred or predicted relationship rules, as well as inferred or predicted violations thereof. In other implementations, UX module 120 may interact with a dedicated client application executing on, for instance, a payor computing system 104 and/or a provider computing system 106.

Reconciliation module 122 may be configured to receive inferences and/or predictions generated by multivariate analyzer 114 and/or ML module 116 and perform various reconciliation routines in response. For example, reconciliation module 122 may be configured to generate output for individuals, e.g., for presentation via UX module 120, that identifies inferred/predicted relationship rules and/or violations thereof. In some implementations, a plurality of digital claims may be evaluated as a batch, and reconciliation module 122 may generate a report flagging those digital claims of the batch that appear to violate inferred and/or predicted compensation relationship rules.

In some implementations, reconciliation module 122 may be configured to take reconciliatory action as part of the reconciliation routine. For example, reconciliation module 122 may evaluate confidence measure(s) generated by multivariate analyzer 114 and/or by ML module 116, e.g., against one or more thresholds. Based on this evaluation, reconciliation module 122 may determine whether to automatically solicit reconciliation from a provider (e.g., by pushing the solicitation to a provider computing system 106), seek confirmation of the violation from a payor first, or perform some other reconciliatory action.

For example, if a confidence measure satisfies a first, highest threshold, indicating high confidence of a compensation relationship rule violation, reconciliation module 122 may automatically solicit reconciliation from a provider, e.g., by requesting the provider (or the patient, if applicable) reimburse the amount of overpayment paid by the payor. If the confidence measure fails to satisfy the first threshold but satisfies a somewhat lower second threshold, reconciliation module 122 may solicit permission/feedback from the payor first, e.g., via a push notification, and may only request reconciliation from the provider if the payor approves. In some implementations, funds may be debited from the provider/patient automatically, e.g., assuming the parties agreed to such an arrangement beforehand.

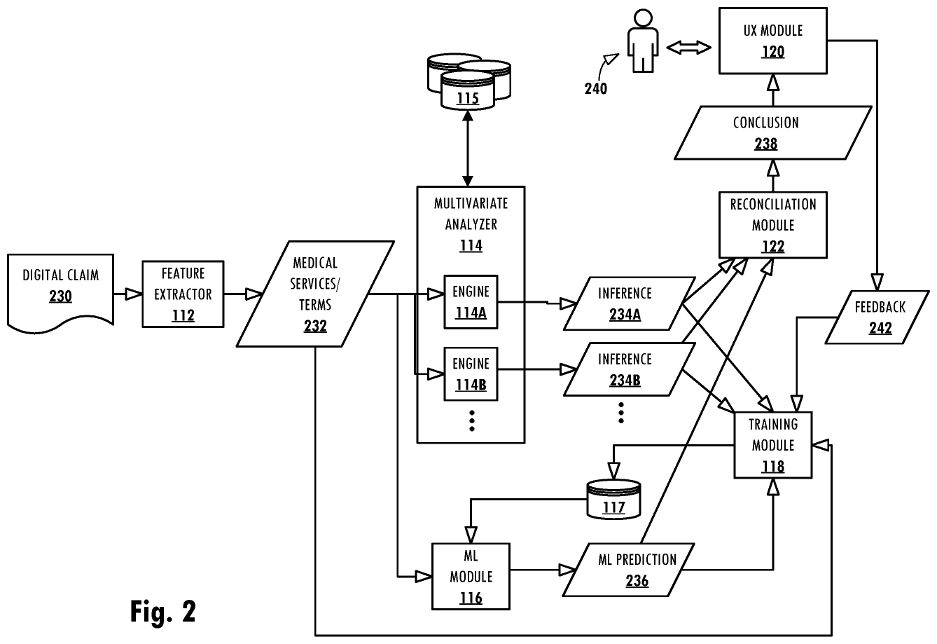

FIG. 2 schematically depicts an example of how aspects of the present disclosure may be implemented, in accordance with various implementations. Starting at left, a digital claim 230 may be provided, for instance, by a payor computing system 104 to compensation reconciliation system 102. Digital claim 230 may be an already-paid claim or a claim that is proposed to be paid. Digital claim 230 may include any number of pieces of information, such as treatment type, provider type, payor type, insurance type, line items for medical goods and/or services (including compensation terms for those goods/services), a total cost of all the line items or subsets of the line item (e.g., items that were covered by insurance and items that were not), and so forth.

Feature extractor 112 may process digital claim 230 to extract features such as medical services (including goods such as pharmaceuticals, durable medical equipment, etc.) and terms 232 under which those services were, or are proposed to be, compensated. In some implementations, feature extractor 112 may extract, or determine based on extracted features, aggregate features such as total amount of reimbursement. In some cases, individual line items of digital claim 230 may not include individual terms (e.g., prices). Instead, a group of line items may be listed in association with (e.g., bundled into) a total price that was or is proposed to be paid.

Medical services/terms 232 may be formulated by feature extractor 112 in various ways. In some implementations, medical services/terms 232 may be formulated as a feature vector, e.g., where each dimension of the feature vector corresponds to a particular feature commonly found in digital claims. In other implementations, feature extractor 112 may utilize one or more machine learning models (not depicted) to encode extracted features into a continuous embedding, with individual dimensions that are unlikely to be meaningful to humans but that are usable by computers to determine things like similarities measures with other embeddings representing other digital claims (or sets of medical services and terms under which those services were compensated).

However medical services/terms 232 are formulated, engines 114A, 114B, . . . of multivariate analyzer 114 may process the extracted features to generate various inferences 234, 234B, . . . . Additionally, a representation of medical services/terms 232 may also be provided to ML module 116. ML module 116 may process these features based on one or more machine learning models 117 to generate output in the form of ML prediction(s) 236. In some implementations, ML prediction(s) 236 may include one or more predicted compensation relationship rules (e.g., that a particular medical service should be reimbursed for a particular price or range of prices). Additionally or alternatively, in some implementations, ML prediction(s) 236 may include a prediction that one or more compensation relationship rules have been violated.

FIG. 2 demonstrates the different stages of training that may be implemented by training module 118 to train one or more machine learning models 117. During a first stage of training, the machine learning model(s) are primed or conditioned so that the model weights are at least somewhat fitted to historical claims data 115 based on inferences generated by multivariate analyzer 114. During a second stage of training, which may occur after and/or in parallel with the first stage, human feedback on predicted compensation relationship rules and/or violations thereof is obtained. That human feedback is used, e.g., by training module 118, to fine tune the machine learning model(s) 117.

In FIG. 2, the first stage of training can be seen where the inferences 234A, 234A, generated by multivariate analyzer 114 and the ML prediction(s) 236 generated by ML module 116 are provided to training module 118. As discussed previously, training module 118 may compare ML prediction(s) to inferences 234A, 234A, . . . to determine error(s). Based on these error(s), training module 118 may train one or more machine learning models 117 using various techniques mentioned previously. Suppose inferences 234A and 234B both indicate that a set of medical services (extracted from digital claim 230) were overpaid by $X, and that ML prediction 236 indicates that the set of medical services were overpaid by $Y. Based on this difference, training module 118 may minimize a loss function associated with the machine learning model(s) by performing techniques such as gradient descent and back propagation using the discrepancy (e.g., error) between $X and $Y.

In FIG. 2, the second stage of training can be seen where the inferences 234A, 234A, generated by multivariate analyzer 114 and the ML prediction(s) 236 generated by ML module 116 are provided to reconciliation module 122. Reconciliation module 122 may process these inferences and/or predictions in various ways to generate one or more conclusions 238 about digital claim 230. For example, if a threshold number or percentage of engines 114A, 114B, . . . and/or inference module agree that digital claim 230 violates a compensation relationship rule—by including an overpayment for one or more medical services, for instance—reconciliation module 122 may generate a conclusion 238 that signals the violation. UX module 120 may cause audio and/or visual output to be presented that conveys conclusion 238 to a user 240 (e.g., an auditor of a payor such as an insurance company).

In some cases, user 240 may interact with UX module 120 (e.g., by interacting with a GUI provided by UX module 120) to provide feedback 242 about conclusion 238. For example, user 240 may flag an overpayment as incorrect or correct, may flag an inferred/predicted compensation relationship rule as being incorrect or correct, or may adjust an inferred/predicted overpayment or rule to a new value. Whichever its form, feedback 242 may be used by training module 118 as to train one or more machine learning models 117.

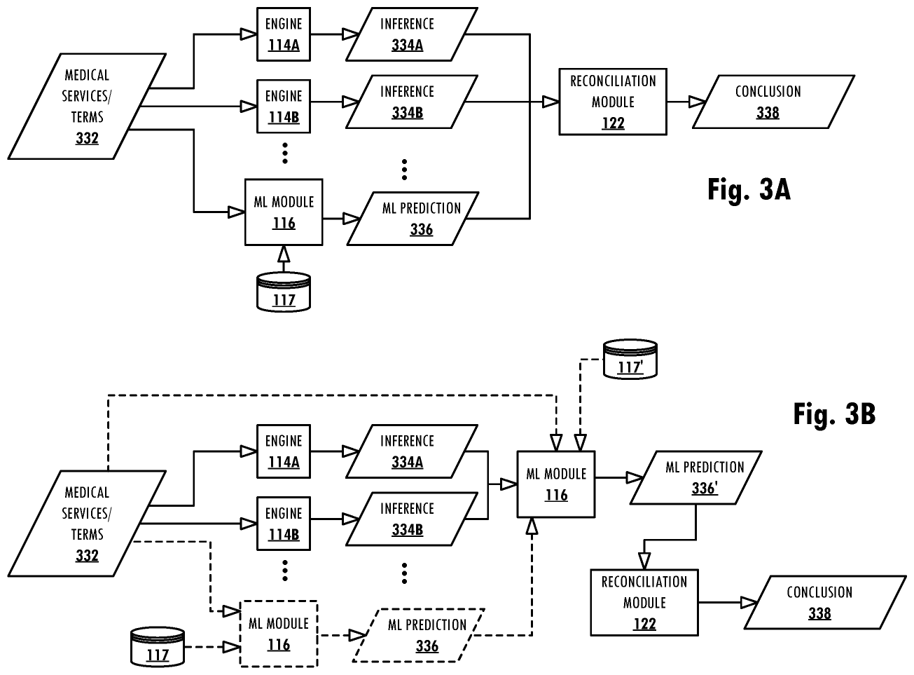

The arrangement of components depicted schematically in FIG. 2 is not meant to be limiting. FIGS. 3A and 3A schematically various arrangements of components that may be implemented in accordance with various aspects of the present disclosure. In FIG. 3A, medical services and terms under which those services were provided 332 are provided to engines 114A, 114B, . . . , and ML module 116 (acting as an additional engine of multivariate analyzer 114). These engines and ML module 116 may generate inferences 334A, 334B, . . . , and ML prediction 336, which in turn are provided to reconciliation module 122. Reconciliation module 122 may provide its conclusion(s) 338, similar to as depicted in FIG. 2. In this example, reconciliation module 122 may weight and/or consider each of inferences 334A, 334B, . . . , and ML prediction 336 in various ways. For instance, if some minimum threshold of these inferences/predictions are in agreement, or within some predetermined variance of each other, then reconciliation may provide a conclusion that conveys, for instance, a potential overpayment amount of potential overpayment range.

FIG. 3B depicts an alternative arrangement of the components depicted in FIGS. 2 and 3A. In FIG. 3B, engines 114A, 114B, . . . once again generate their respective inferences 334A, 334B, . . . based on medical services and terms under which a set of services were provided 332. As indicated by the dashed lines, ML module 116 can optionally provide ML prediction 336A as an additional data point. In FIG. 3B, inferences 334A, 334B, . . . (and prediction 336A, if present) are not provided directly to reconciliation module 122, as was the case in FIGS. 2 and 3A. Instead, in FIG. 3B, these data are processed downstream by ML module 116, e.g., using one or more additional machine learning models 117′. These additional machine learnings models 117′ may be trained based on training data that includes historical inferences 334 drawn by engines 114A, 114B, . . . , human feedback responsive to conclusion 338, and where applicable, historical ML predictions 336 generated by ML module 116.

For instance, ML module 116 may apply data indicative of inferences 334A, 334B, . . . , (and ML prediction 336 if available), such as a feature vector with each dimension populated by a respective inference/ML prediction, as input across one or more additional machine learning models 117, such as a SVM, neural network, etc. The resulting ensemble ML prediction 336′ may be processed by reconciliation module 122 to generate a conclusion that is conveyed to a human via UX module 120 (not depicted in FIG. 3B). The human may provide feedback that is then used to train the additional machine learning model 117′. For example, if the ensemble ML prediction 336 identified an overpayment which was then rejected, that feedback may be used by training module 118 (not depicted in FIG. 3B) to train the additional machine learning model(s) 117′.

In this way, engines 114A, 114B, . . . and ML module 116 may be implemented as an ensemble of processes that collectively generate an ensemble ML prediction 336′. Ensemble ML prediction 336′ may indicate one or more predicted compensation relationship rules and/or violation(s) thereof. Reconciliation module 122 may then process ensemble ML prediction 336′ to generate a conclusion 338.

In various implementations, various parameters associated with the pipelines depicted in FIGS. 2, 3A, and/or 3B may be adjustable to increase and/or decrease the rate at which compensation relationship rule violations are flagged or not flagged, and/or the rate at which compensation reconciliation routines are triggered. In some implementations in which multivariate analyzer 114 employs multiple engines (114A, 114B, . . . ), a minimum number of engines that need to corroborate a violation in order to trigger a compensation reconciliation routine may be adjustable.

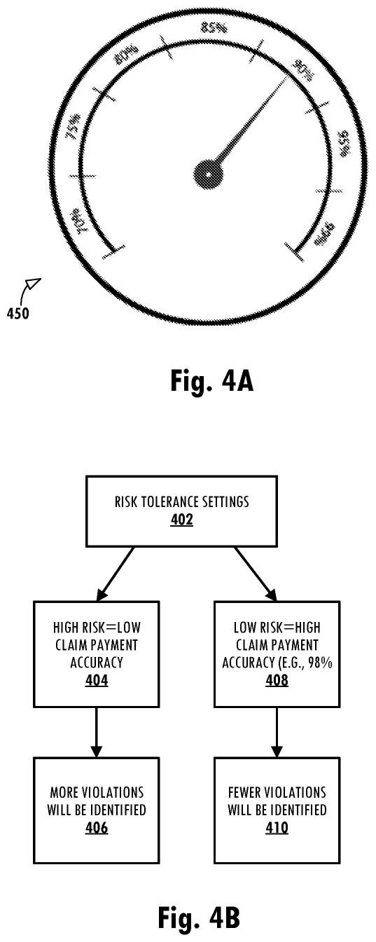

Additionally or alternatively, in some implementations, a minimum confidence threshold may be adjusted for one or more of the engines implemented by multivariate analyzer 114. If this minimum confidence threshold is not satisfied by at least one engine (or some adjustable number of engines), then no violation may be identified, or compensation reconciliation routine triggered. An example graphical element 450 is depicted in FIG. 4A as a dial that depicts a minimum confidence or accuracy threshold (set to 90% in this example). In some implementations, graphical element 450) may be interactive so that a user (not depicted) can adjust one or more parameters associated with inferring and/or predicting compensation relationship rules or violations thereof.

In some implementations, a combination of minimum confidence thresholds and threshold numbers of engines in agreement may be required. In some such implementations a sliding scale may be employed. For instance, if one or more of the engines implemented by multivariate analyzer 114 generate inferences/conclusions at a very high confidence measure, even if other engines disagree (or agree with very low confidence measures), reconciliation module 122 (or inference module 106 in FIG. 3B) may identify a compensation relationship rule and/or violation thereof. Likewise, reconciliation module 122 may identify a compensation relationship rule violation if a large number/percentage of engines agree, even if the constituent engines' confidence measures are relatively low.

FIG. 4B schematically demonstrates an example of risk tolerance levels that may be taken into account when adjusting parameters used by various processes described herein, in accordance with various implementations. At block 402, one or more risk tolerance settings may be adjusted, e.g., using a graphical element such as that depicted in FIG. 4A to adjust a minimum confidence or accuracy threshold. If, at block 404, a higher risk tolerance is selected, say, by setting a target accuracy to 78% of claim volume compensated properly, then at block 406, more violations are likely to be identified, with the potential to capture more genuine violations that might not otherwise have been captured but also the potential for more false-positives. By contrast, suppose that at block 408, lower risk is selected, say, by setting a target accuracy to 98% of claim volume compensated properly. At block 410, and in contrast to block 406, fewer violations may be identified. This may result in more genuine violations falling through the cracks but also may result in fewer false positives.

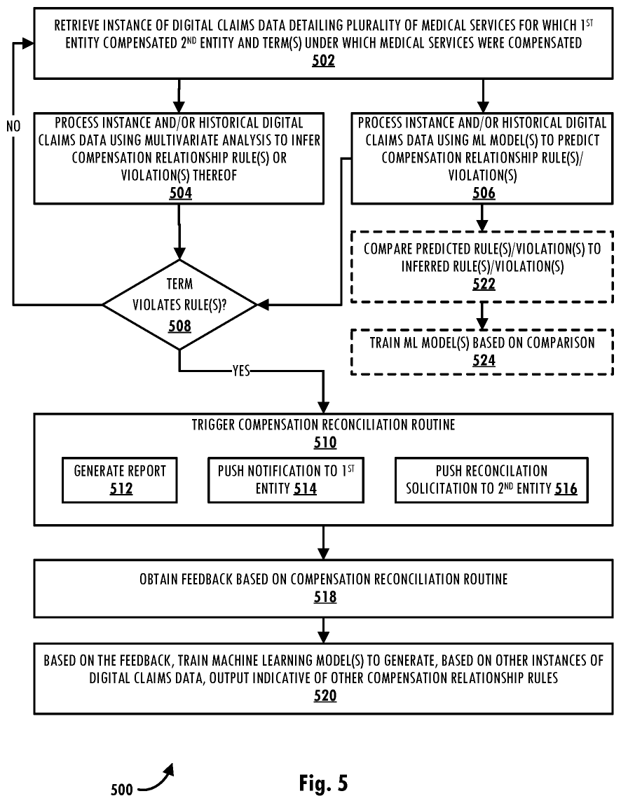

FIG. 5 is a flowchart illustrating an example method 500 of performing selected aspects of the present disclosure, in accordance with various implementations. For convenience, the operations of the flow chart are described with reference to a system that performs the operations. This system may include various components of various computer systems, such as one or more components of compensation reconciliation system 102. Moreover, while operations of method 500 are shown in a particular order, this is not meant to be limiting. One or more operations may be reordered, omitted or added.

At block 502, the system, e.g., by way of feature extractor 112, may retrieve an instance of digital claims data (e.g., 230) detailing a plurality of medical services for which a first entity compensated a second entity and one or more terms under which the medical services were compensated. While not depicted in FIG. 5, in some implementations, the operations of block 502 may also include extracting features from the instance of digital claims data. For example, if the instance of digital claims data is in a raster format (e.g., PDF, JPEG, PNG), feature extractor 112 or another component of compensation reconciliation system 102 may perform optical character recognition (OCR) on the instance of digital claims data to extract text. Feature extractor 112 may then analyze this text using various feature extraction and/or natural language processing techniques to extract features of the instance of digital claims data. These extracted features may include the plurality of medical services (e.g., pharmaceuticals, treatments, labs, tests, therapies, etc.) for which the first entity compensated the second entity and/or the terms under which the medical services were (or are proposed to be) compensated.

At block 504, the system, e.g., by way of multivariate analyzer 114, may process historical digital claims data (e.g., 115) of the first or second entity using multivariate analysis to infer one or more compensation relationship rules that govern compensation for medical services between the first and second entities, and/or to infer one or more violations of the one or more compensation relationship rules. For example, one engine 114A may employ centroid and cluster analysis. Another engine 114B may employ Z-scoring analysis. Another engine may employ whisker and box quartile analysis. Another engine may employ banding. In some implementations, at block 506, ML module 116 may act as yet another engine that predicts compensation relationship rules and/or violations thereof. In particular, ML module 116 may process historical digital claims data and/or the instance of digital claims data using machine learning model(s) 117 to predict compensation relationship rules and/or violations thereof.

At block 508, the system, e.g., by way of compensation reconciliation module 122, may determine whether one or more of the terms under which the medical services were compensated violate one or more of the rules that govern compensation between the first and second entities. If the answer is no, then method 500 may return to block 502 and a next instance of digital claims data may be evaluated. However, if the answer at block 508 is yes, then at block 510, a compensation reconciliation routine may be triggered on behalf of the second entity.

A compensation reconciliation routine may include a variety of different actions. At block 512, a report may be generated, e.g., by reconciliation module 122 or UX module 120, that identifies the instance of digital claims data as violating one or more compensation relationship rules. In some implementations, the report may be a batch report that flags a plurality of violations. Additionally or alternatively, at block 514, reconciliation module 122 may generate and/or push (e.g., via UX module 120) a notification to the first entity, e.g., to payor computing system 104 in FIG. 1, that the instance of digital claims data included a potential violation of a compensation relationship rule.

Additionally or alternatively, at block 516, reconciliation module 122 may push a reconciliation solicitation to the second entity, e.g., to provider computing system 106 and/or to a computing device or system operated by a patient to which the medical services were provided by the second entity. For example, if the compensation relationship rule violation is identified with a measure of confidence that satisfies a first threshold, reconciliation module 122 may push the solicitation to the second entity/patient as shown at block 516. If the compensation relationship rule violation is identified with a measure of confidence that fails to satisfy the first threshold but satisfies a second (e.g., lower) threshold, reconciliation module 122 may push the notification to the first entity (e.g., payer such as an insurance company) at block 514. Other reconciliation actions are contemplated, such as automatically debiting funds from the second entity/patient if the violation is identified with a sufficiently high confidence measure (and assuming the right to automatically debit has been negotiated previously), automatically seeking a lien against the second entity/patient, etc.

At block 518, the system, e.g., by way of UX module 120, may obtain feedback based on the compensation reconciliation routine triggered at block 510. For example, an auditor operating a payor computing system 104 may review a report generated at block 512 and/or a notification pushed to them at block 514. Based on the audit, the auditor may accept or reject the identified violation as a bona fide violation of one or more compensation relationship rules. Based on the feedback, at block 520, training module 118 may use this acceptance or rejection to train one or more machine learning model(s) 117 to generate, based on other instances of digital claims data detailing entities providing medical services to other entities, output indicative of other compensation relationship rules.

In some implementations, the training of blocks 518-520 may be performed on an ongoing basis, e.g., even after the machine learning model(s) 117 are trained to some threshold amount of convergence. This allows the machine learning model(s) 117 become capable of more accurately predicting compensation relationship rules and/or violations thereof over time. This may also allow the machine learning model(s) 117 evolve with the underlying data, such as historical data 115, over time. For example, payors and providers (and patients, where applicable) may renegotiate compensation relationship rules such as reimbursement rates, drug prices, etc. as time passes. These changes may be reflected in the historical data 115 over time, and hence, may be “learned” by the machine learning model(s) 117 over time.

The training of blocks 518-520 also may be performed in some implementations to “fine tune” the machine learning model(s) 117. In some such implementations, the machine learning model(s) 117 may be initially trained based on output of other engines of multivariate analyzer 114 that do not rely on trained machine learning models. For example, compensation relationship rules and/or violations thereof (e.g., inferences 234A, 234B, . . . ) that are identified by engines 114A, 114B, . . . may be compared at block 522 to predictions (e.g., ML prediction 236) to determine an error associated with the machine learning model(s) 117. This error may be used by training module 118 at block 524 to train the machine learning model(s) 117, e.g., using techniques such as gradient descent, back propagation, etc.

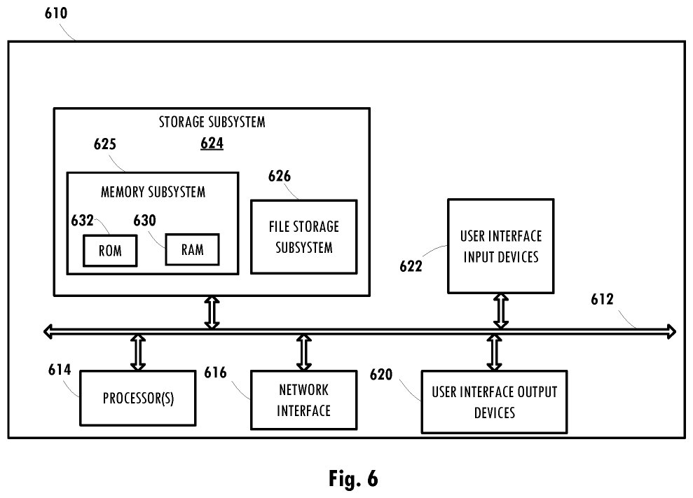

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the method of FIG. 5, as well as to implement various components depicted in FIG. 1, 2, or 3A-B.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented using one or more processors, comprising:
retrieving an instance of digital claims data detailing a plurality of medical services for which a first entity compensated a second entity and one or more terms under which the medical services were compensated;
processing historical digital claims data of the first or second entity using multivariate analysis to infer one or more compensation relationship rules that govern compensation for medical services between the first and second entities;
in response to a determination that one or more of the terms under which the medical services were compensated violate one or more of the rules that govern compensation between the first and second entities, triggering a compensation reconciliation routine on behalf of the second entity;
obtaining feedback based on the compensation reconciliation routine; and
based on the feedback, training one or more machine learning models to generate, based on other instances of digital claims data detailing entities providing medical services to other entities, output indicative of other compensation relationship rules.

2. The method of claim 1, wherein the processing includes processing both the historical digital claims data and the instance of digital claims data using multivariate analysis.

3. The method of claim 1, wherein the processing includes clustering the instance of digital claims data with additional instances of the historical claims data based on the plurality of medical services.

4. The method of claim 3, further comprising:
identifying a centroid of the cluster; and
inferring one or more of the rules based on the centroid of the cluster.

5. The method of claim 4, further comprising:
determining a distance between an embedding representing the instance of digital claims data and the centroid; and
determining that one or more of the terms violate one or more of the rules based on the distance.

6. The method of claim 1, wherein the multivariate analysis comprises a plurality of multivariate analysis techniques, and the method comprises determining that one or more of the terms under which the medical services were compensated violate one or more of the rules that govern compensation between the first and second entities based on outcomes of the plurality of multivariate analysis techniques.

7. The method of claim 6, wherein the plurality of multivariate analysis techniques include one or more of Z-scoring analysis, whisker and box quartile analysis, or banding.

8. The method of claim 1, wherein the method further comprises processing the instance of digital claims data using one or more of the machine learning models to generate an embedding.

9. The method of claim 8, wherein the training comprises training one or more of the machine learning models using a triplet loss function based on the embedding and two or more other embeddings generated from the historical digital claims data.

10. The method of claim 1, further comprising:
processing the instance of digital claims data using one or more of the machine learning models to generate a prediction of whether one or more of the terms under which the medical services were compensated violate one or more of the rules that govern compensation between the first and second entities;
comparing the prediction to the determination; and
training one or more of the machine learning models based on the comparing.

11. The method of claim 1, further comprising:
processing the instance of digital claims data using one or more of the machine learning models to predict one or more compensation rules under which the medical services were compensated;
comparing the predicted one or more compensation rules to the inferred one or more compensation relationship rules; and
training one or more of the machine learning models based on the comparing.

12. A method implemented using one or more processors, comprising:
retrieving an instance of digital claims data detailing a plurality of medical services for which a first entity compensated a second entity and one or more terms under which the medical services were compensated;
processing historical digital claims data of the first or second entity using multivariate analysis to generate one or more inferences of one or more compensation relationship rules that govern compensation for medical services between the first and second entities;
processing the instance of digital claims data using one or more machine learning models to generate one or more predictions of one or more compensation rules under which the medical services were compensated or one or more violations of one or more compensation rules under which the medical services were compensated;
comparing one or more of the inferences to one or more of the predictions; and
training one or more of the machine learning models based on the comparing.

13. The method of claim 12, further comprising:
in response to a determination that one or more of the terms under which the medical services were compensated violate one or more of the inferred or predicted rules that govern compensation between the first and second entities, triggering a compensation reconciliation routine on behalf of the second entity.

14. The method of claim 13, further comprising:
obtaining feedback based on the compensation reconciliation routine; and
based on the feedback, training one or more of the machine learning models to generate, based on other instances of digital claims data detailing entities providing medical services to other entities, predictions of other compensation relationship rules or violations thereof.

15. A system comprising one or more processors and memory storing instructions that, in response to execution by the one or more processors, cause the one or more processors to:
retrieve an instance of digital claims data detailing a plurality of medical services for which a first entity compensated a second entity and one or more terms under which the medical services were compensated;
process historical digital claims data of the first or second entity using multivariate analysis to infer one or more compensation relationship rules that govern compensation for medical services between the first and second entities;
in response to a determination that one or more of the terms under which the medical services were compensated violate one or more of the rules that govern compensation between the first and second entities, trigger a compensation reconciliation routine on behalf of the second entity;
obtain feedback based on the compensation reconciliation routine; and
based on the feedback, train one or more machine learning models to generate, based on other instances of digital claims data detailing entities providing medical services to other entities, output indicative of other compensation relationship rules.

16. The system of claim 15, wherein the instructions to process include instructions to process both the historical digital claims data and the instance of digital claims data using multivariate analysis.

17. The system of claim 15, wherein the instructions to process include instructions to cluster the instance of digital claims data with additional instances of the historical claims data based on the plurality of medical services.

18. The system of claim 17, further comprising instructions to:
identify a centroid of the cluster; and
infer one or more of the rules based on the centroid of the cluster.

19. The system of claim 18, further comprising instructions to:
determine a distance between an embedding representing the instance of digital claims data and the centroid; and
determine that one or more of the terms violate one or more of the rules based on the distance.

20. The system of claim 15, wherein the multivariate analysis comprises a plurality of multivariate analysis techniques, and the system comprises instructions to determine that one or more of the terms under which the medical services were compensated violate one or more of the rules that govern compensation between the first and second entities based on outcomes of the plurality of multivariate analysis techniques.
